(19) United States
(12) Patent Application Publication
(10) Pub. No.: US 2026/0048609 A1
(43) Pub. Date: Feb. 19, 2026

(54) CONTRACTOR PENCIL SLEEVE HAVING A MAGNET AND HOOK AND LOOP FASTENER

(71) Applicant: Jaron Solis, Remington, VA (US)

(72) Inventor: Jaron Solis, Remington, VA (US)

(21) Appl. No.: 18/806,378

(22) Filed: Aug. 15, 2024

(51) Int. Cl. B43K 25/00; B43K 29/08

(52) U.S. Cl. CPC B43K 25/00; B43K 29/08

(57) ABSTRACT

A contractor pencil sleeve having a magnet and hook and loop fastener is provided. The contractor pencil sleeve may comprise a cylindrical body. A magnet may be attached to a first side of the cylindrical body. A hook and loop fastener strip may be attached to a second side of the cylindrical body opposite the first side. The cylindrical body may be 1 inch in length. The cylindrical body may be sized to fit most standard contractor pencils. The magnet may be thin and high-quality. The hook and loop fastener strip may be durable and securely affixed. The cylindrical body may be made of a durable material. The durable material may be plastic or lightweight metal. The sleeve may be attachable to various surfaces via the magnet or the hook and loop fastener strip. The sleeve may serve as a reference for 1-inch measurements.

### FIELD OF THE INVENTION

The present disclosure relates to accessories for contractor pencils.

### BACKGROUND

Contractor pencils may be used in construction, renovation, and general DIY environments. These environments may be dynamic and often cluttered settings where tools and accessories may be prone to misplacement.

In conventional situations, contractors may often face difficulties in managing small yet essential tools such as contractor pencils, which may be frequently needed yet easily misplaced in the busy and sometimes chaotic environments of work sites. Contractor pencils, while vital for marking and layout tasks, may be commonly left behind or lost among other materials and equipment. This misplacement can disrupt work flow and decrease productivity as workers may spend time searching for these tools instead of performing their tasks.

Additionally, when quick measurements are needed, the typical process involves retrieving and using separate measuring devices, which may not always be immediately accessible. This can lead to interruptions and further inefficiency in the workflow. The ability to quickly and easily perform minor measurement tasks on the spot without needing to locate a separate tool could provide substantial time savings and improve work efficiency.

Moreover, the standard methods of storing contractor pencils, such as in pockets or tool belts, may not adequately address the need for immediate and convenient access during various tasks. These methods may also not ensure visibility or reachability of the pencil when it is most needed, potentially leading to situations where the pencil is not easily retrievable. Furthermore, these conventional storage solutions do not provide any additional functionality to the contractor pencil, leaving its capabilities solely to marking.

The challenges faced in maintaining accessibility, preventing misplacement, and facilitating quick measurements with contractor pencils in construction and similar settings demonstrate a need for improved approaches in managing these tools in work environments.

The conventional strategy is to manually store or hold the pencil, which often causes problems because this method does not secure the pencil at a fixed location for immediate and repeated access. Moreover, workers may need to interrupt their tasks to search for the pencil if it is not well-placed, which may lead to delays and disruptions in work progress. Additionally, the requirement for quick measurement checks may necessitate the use of separate measuring tools, potentially increasing the time spent on minor tasks.

Consequently, there may be a need for a method that allows for the convenient placement and easy accessibility of contractor pencils at a worksite, reducing the likelihood of pencil misplacement. There may also be a need for a solution that incorporates a measurement aid, which may facilitate quick, minor measurement tasks without requiring additional tools, thereby enhancing overall work efficiency and productivity. The frequent challenges of managing and utilizing contractor pencils in manual labor tasks underscore the potential benefits of addressing these issues.

### SUMMARY

A contractor pencil sleeve having a magnet and hook and loop fastener may be provided. A contractor pencil sleeve may be provided. The sleeve may be designed to fit around standard contractor pencils. The sleeve may include a magnet on one side. The sleeve may include Hook and loop fastener on an opposing side. The sleeve may be attachable to various surfaces. The sleeve may serve as a reference for measurements.

These together with additional objects, features and advantages of the systems and methods of fraud identification will be readily apparent to those of ordinary skill in the art upon reading the following detailed description of the presently preferred, but nonetheless illustrative, embodiments when taken in conjunction with the accompanying drawings.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a perspective view of a sleeve according to an embodiment.

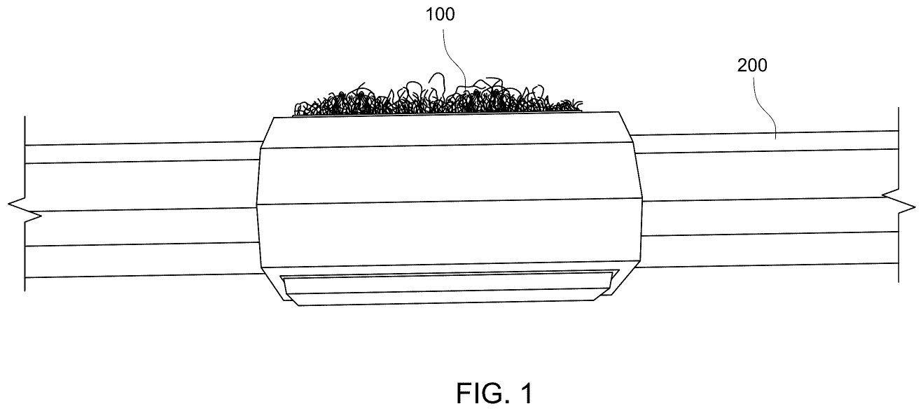

FIG. 2 is a side view of the sleeve of FIG. 1.

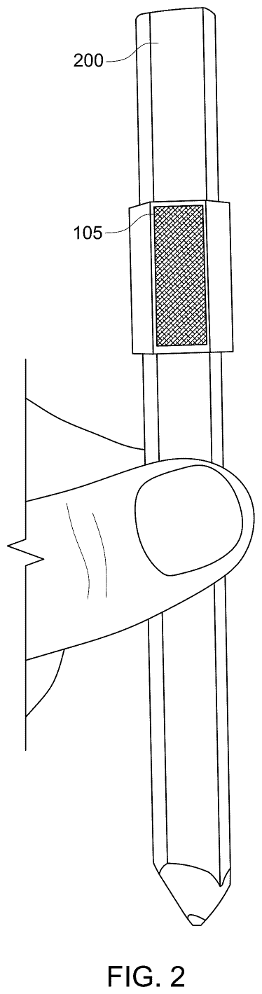

FIG. 3 is a side view of the sleeve of FIG. 1.

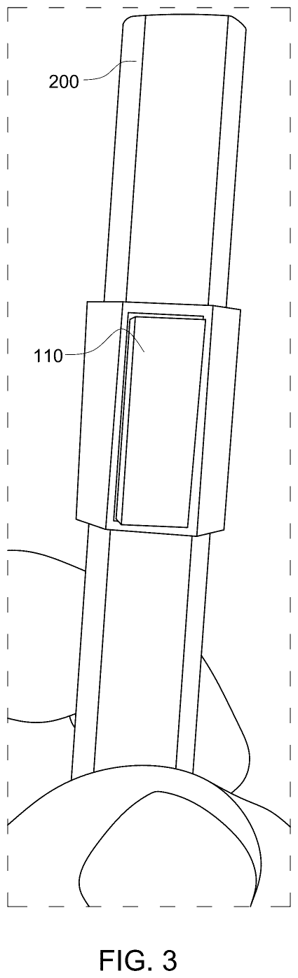

FIG. 4, 400 shows such ruler reference measurements which may be included on one or more sides of the sleeve for a contractor pencil.

### DETAILED DESCRIPTION

The present disclosure includes many aspects and features. Moreover, while many aspects and features relate to, and are described in embodiments of the present disclosure are not limited to use only in this context. The present disclosure can be understood more readily by reference to the following detailed description of the disclosure and the examples included therein.

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

Reference will now be made in detail to embodiments of the present disclosure, examples of which are illustrated in the accompanying drawings. Wherever possible, the same reference numbers will be used throughout the drawings to refer to the same or like parts.

A contractor pencil sleeve having a magnet and hook and loop fastener may be provided. The sleeve may be cylindrical. The sleeve may measure 1 inch in length. The sleeve may be designed to fit around standard contractor pencils. The sleeve may be sized to fit most or all standard contractor pencils.

The sleeve may include a magnet. The magnet may be attached to one side of the sleeve. The magnet may be thin. The magnet may be high-quality. The magnet may be capable of adhering to metal surfaces.

The sleeve may include a hook and loop fastener. The hook and loop fastener may be Velcro. The hook and loop fastener may be attached to a side of the sleeve opposite the magnet. The hook and loop fastener may be a strip. The hook and loop fastener may be durable. The hook and loop fastener may be affixed securely. The hook and loop fastener may allow for multiple attachments and detachments.

The sleeve may be made of a durable material. The material may be plastic. The material may be a lightweight metal. The material may withstand rigors of a construction environment. The material may not add significant weight to the pencil.

The sleeve may be attachable to various surfaces. The sleeve may be attachable to surfaces around homes. The sleeve may be attachable to surfaces around job sites. The sleeve may be attachable via the magnet. The sleeve may be attachable via the hook and loop fastener. In one or more embodiments, the sleeve for a contractor pencil may further comprise a clip fastener that may fasten to a shirt, garment, pocket, or article of fabric.

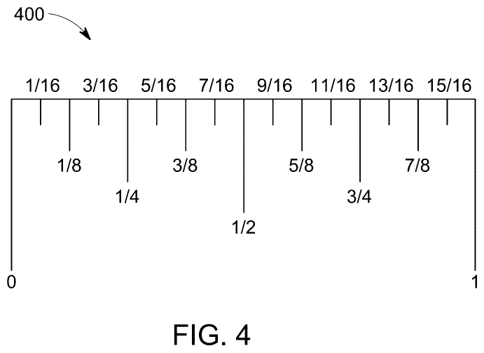

The sleeve may serve as a reference for measurements. The sleeve may serve as a reference for 1-inch measurements. FIG. 4, 400 shows such ruler reference measurements which may be included on one or more sides of the sleeve for a contractor pencil. In one or more alternative embodiments, the sleeve for a contractor pencil may be configured to fit a specific measurement. In one or more embodiments, this specific measurement may be one inch in length. In one or more embodiments, this specific measurement may be another length. The sleeve may enhance utility in construction projects. The sleeve may enhance utility in DIY projects.

In one or more alternative embodiments a sleeve for a contractor pencil may comprise a cylindrical body. A magnet may be attached to a first side of the cylindrical body. A hook and loop fastener strip may be attached to a second side of the cylindrical body opposite the first side.

Alternatively, the sleeve may include a color indicator. The color indicator may be located on the exterior of the sleeve. The color indicator may facilitate quick identification of the sleeve among other tools. The color indicator may be composed of reflective material. The color fibers may enhance visibility in low light conditions.

The sleeve may be resistant to environmental factors such as dust, moisture, and chemicals commonly found in construction sites. This resistance may help in maintaining the integrity and functionality of the sleeve over time. The materials used may include coatings or treatments that repel water, oil, and dirt.

The sleeve may incorporate a textured surface. This texture may improve grip and handling. The texturing may be on the outer surface of the sleeve. The texturing may prevent the sleeve from slipping out of hands or off surfaces, especially when gloves are used.

The magnetic feature of the sleeve may be optimized for strength and durability. The magnet may be embedded within the wall of the sleeve. Embedding the magnet may protect it from physical damage and corrosion. The embedded magnet may still provide sufficient magnetic force to hold the sleeve securely to metal surfaces.

The hook and loop fastener may be designed for ease of use. The fastener may feature a pull tab. The pull sash may assist in quick detachment of the sleeve from surfaces or from the pencil. The pull tab may be made of a material that is robust and easy to grasp.

The sleeve may be available in multiple sizes to accommodate different sizes of contractor pencils. Each size may maintain the same functionality, including the magnetic and hook and loop fastener features. The variety in sizes may ensure that users can find a sleeve that fits their specific pencil size perfectly.

The sleeve may be configurable to different environments commonly encountered in construction or DIY projects. The ability of the sleeve to adapt to varying conditions may be facilitated by the choice of materials and the design of the attachment mechanisms, such as the magnet and hook and loop fastener.

The sleeve may further comprise a visual indicator. The visual indicator may be located on the exterior of the sleeve. The visual indicator may be used to denote the one-inch measurement feature of the sleeve. The visual indicator may be a mark, stripe, or any other suitable form of marking that is easily discernible.

The sleeve may also include a textured surface. The textured surface may be on the exterior of the sleeve. The textured surface may enhance grip. The textured surface may prevent the sleeve from slipping when held or when placed on smooth surfaces. This texturing may be particularly useful in environments where gloves are typically worn, such as construction sites.

The sleeve may be offered in various colors. The choice of colors may be aesthetically pleasing or may serve a functional purpose such as high visibility for easy location on a cluttered job site or in low light conditions.

The sleeve may be designed to be stackable with similar units. This stackability may facilitate organized storage and transport of multiple sleeves and pencils. The design may include features that interlock when multiple sleeves are aligned and stacked.

The sleeve may include an identification tag area. The identification tag area may be a surface or slot on the sleeve designed to hold a label, tag, or other identifier. This feature may be useful for personalization or for professionals who need to label their tools as part of inventory management or job site requirements.

The sleeve may be designed to resist common chemicals found in construction environments. This chemical resistance may prevent degradation of the sleeve material when exposed to substances like solvents, oils, or greases, thus extending the life and utility of the sleeve.

The sleeve may be manufactured using environmentally friendly processes and materials. This may appeal to users and companies that prioritize sustainability in their purchasing decisions. The use of recycled materials or materials that are easier to recycle may be part of this environmentally friendly approach.

These embodiments and configurations, demonstrating the sleeve's adaptability and functionality, underscore its utility in a variety of scenarios, thereby broadening its applicability and appeal in the market.

The contractor pencil sleeve 100 may comprise a cylindrical body. The cylindrical body may be sized to fit most standard contractor pencils 200. The cylindrical body may be 1 inch in length. The cylindrical body may be made of a durable material. The durable material may be plastic or lightweight metal.

A magnet 110 may be attached to a first side of the cylindrical body. The magnet 110 may be thin and high-quality. A hook and loop fastener strip 105 may be attached to a second side of the cylindrical body opposite the first side. The hook and loop fastener strip 105 may be durable and securely affixed.

The sleeve 100 may be attachable to various surfaces via the magnet 110 or the hook and loop fastener strip 105. The sleeve 100 may serve as a reference for 1-inch measurements.

A method of using the sleeve 100 for a contractor pencil 200 may include sliding the sleeve 100 over the contractor pencil 200. The method may include positioning the sleeve 100 securely on the pencil 200. The method may include attaching the pencil 200 to a surface using the magnet 110 or hook and loop fastener strip 105 on the sleeve 100.

The method may include using the sleeve 100 as a measurement reference. Using the sleeve 100 as a measurement reference may include employing the 1-inch length of the sleeve 100. The method may include storing the pencil 200 by attaching it to a convenient surface via the sleeve 100. The method may include enhancing work efficiency by keeping the pencil 200 readily accessible.

A system for enhancing utility of a contractor pencil 200 may comprise the sleeve 100 having the cylindrical body. The system may include the magnet 110 attached to the first side of the cylindrical body. The system may include the hook and loop fastener strip 105 attached to the second side of the cylindrical body opposite the first side. The system may include the contractor pencil 200 inserted into the sleeve 100.

The sleeve 100 may transform the contractor pencil 200 into a multifunctional tool. The multifunctional tool may be capable of attachment to various surfaces and may provide measurement capabilities.

The method of using the sleeve may involve placing the contractor pencil into the sleeve until it is snug. This placement may ensure that the pencil does not slide out during normal usage. The method may also involve removing the pencil by applying a slight pressure to one end while holding the sleeve steady.

The system may further include a storage container for the sleeve when not in use. The storage container may be magnetically attachable to metal surfaces. The container may protect the sleeve from physical damage and keep it readily accessible. The storage container may also be stackable, facilitating organized storage of multiple sleeves.

These embodiments and features of the sleeve provide for a versatile and functional tool accessory that enhances the usability and accessibility of contractor pencils on job sites and in DIY projects, fulfilling the disclosed objectives of the sleeve.

The cylindrical body may measure 1 inch in length. The cylindrical body may be sized to fit most standard contractor pencils. The magnet may be thin and high-quality. The hook and loop fastener strip may be durable and securely affixed. The cylindrical body may be made of a durable material, which may be plastic or a lightweight metal. The sleeve may be attachable to various surfaces via the magnet or the hook and loop fastener strip.

A method of using the sleeve may be provided. The method may include sliding the sleeve over a contractor pencil. The method may include positioning the sleeve securely on the pencil. The method may include using the magnet to attach the pencil to a metal surface. The method may include using the Hook and loop fastener to attach the pencil to a non-metal surface.

The method may include using the sleeve as a measurement reference. The method may include employing the 1-inch length of the sleeve for measurement. The method may include using the sleeve for quick measurements during tasks.

The method may include storing the pencil. The method may include attaching the pencil via the sleeve to a convenient surface. The method may include keeping the pencil within reach. The method may include preventing loss of the pencil. The method may include enhancing work efficiency. The method may include keeping the pencil readily accessible. The method may include reducing time spent searching for misplaced items.

The sleeve may transform the pencil. The sleeve may transform the pencil from a standalone writing instrument. The sleeve may transform the pencil to a multifunctional tool. The transformed pencil may be capable of attachment to various surfaces. The transformed pencil may provide measurement capabilities.

Contractor pencils are commonly utilized in construction and other manual labor fields where precise marking is required. However, these pencils may be easily misplaced or lost during the course of work. Such misplacement may interrupt the workflow and reduce efficiency. Traditionally, contractor pencils may be stored in pockets or tool belts, but these methods do not necessarily ensure the pencil's accessibility when it is needed immediately at a specific location.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A sleeve for a contractor pencil, comprising:
a cylindrical body;
a magnet attached to a first side of the cylindrical body; and
a hook and loop fastener strip attached to a second side of the cylindrical body opposite the first side.

2. The sleeve of claim 1, wherein the cylindrical body is 1 inch in length.

3. The sleeve of claim 1, wherein the cylindrical body is sized to fit most standard contractor pencils.

4. The sleeve of claim 1, wherein the magnet is thin and high-quality.

5. The sleeve of claim 1, wherein the Hook and loop fastener strip is durable and securely affixed.

6. The sleeve of claim 1, wherein the cylindrical body is made of a durable material.

7. The sleeve of claim 6, wherein the durable material is plastic or lightweight metal.

8. The sleeve of claim 1, wherein the sleeve is attachable to various surfaces via the magnet or the hook and loop fastener strip.

9. The sleeve of claim 1, wherein the sleeve serves as a reference for 1-inch measurements.

10. A method of using a sleeve for a contractor pencil, comprising:
sliding the sleeve over a contractor pencil;
positioning the sleeve securely on the pencil;
attaching the pencil to a surface using a magnet or Hook and loop fastener strip on the sleeve.

11. The method of claim 10, further comprising using the sleeve as a measurement reference.

12. The method of claim 11, wherein using the sleeve as a measurement reference includes employing a 1-inch length of the sleeve.

13. The method of claim 10, further comprising storing the pencil by attaching it to a convenient surface via the sleeve.

14. The method of claim 10, further comprising enhancing work efficiency by keeping the pencil readily accessible.

15. A system for enhancing utility of a contractor pencil, comprising:
a sleeve having a cylindrical body;
a magnet attached to a first side of the cylindrical body;
a hook and loop fastener strip attached to a second side of the cylindrical body opposite the first side; and
a contractor pencil inserted into the sleeve.

16. The system of claim 15, wherein the cylindrical body is 1 inch in length.

17. The system of claim 15, wherein the sleeve is attachable to various surfaces via the magnet or the Hook and loop fastener strip.

18. The system of claim 15, wherein the sleeve serves as a reference for 1-inch measurements.

19. The system of claim 15, wherein the sleeve transforms the contractor pencil into a multifunctional tool.

20. The system of claim 19, wherein the multifunctional tool is capable of attachment to various surfaces and provides measurement capabilities.
